(19) United States
(12) Patent Application Publication
(10) Pub. No.: US 2020/0116174 A1
(43) Pub. Date: Apr. 16, 2020

(54) CLIP AND COVER ASSEMBLY

(71) Applicant: Proline Products (NZ) Limited, Napier (NZ)

(72) Inventor: Gerald Brent Mossman, Havelock North (NZ)

(21) Appl. No.: 16/599,108

(22) Filed: Oct. 10, 2019

(30) Foreign Application Priority Data
Oct. 12, 2018 (NZ) 747098

(51) Int. Cl. F16B 2/10

(52) U.S. Cl. CPC F16B 2/10

(57) ABSTRACT

Described is a clip comprising first and second clip body portions, each clip body portion including an elongate partial channel; a hinge connecting the first and second clip body portions and configured to allow movement of the first and second clip body portions between an open configuration and a closed configuration; wherein, in the closed configuration, the partial channels of the first and second clip body portions together form an elongate channel with a load-bearing inner surface on a side of the channel substantially opposite the hinge.

### CROSS-REFERENCE TO RELATED APPLICATIONS

The present application claims priority to New Zealand Application No. NZ 747098 filed on Oct. 12, 2018 with the Intellectual Property Office of New Zealand, which is incorporated herein by reference in its entirety for all purposes.

### FIELD OF THE INVENTION

This invention relates to a clip. The invention also relates to an assembly including a clip and a cover.

### BACKGROUND OF THE INVENTION

Clips are useful in many situations. For example, they can be used to connect two similar items such as sheets of paper together, connect an item such as a fabric cover to a support, and hold an item such as a folder closed.

One use of clips is to attach a cover made of a sheet or netting of fabric to ropes, cables or wires. These covers can be used to protect plants including trees from excessive sun, rain, wind, frost and other adverse weather conditions, and to keep insects, birds and other pests off plants.

Commonly, clips for covers attach to the fabric of the cover with multiple pins or barbs that penetrate the fabric. Each clip may also be attached to a rope or other support. Opposite sides of the cover are typically connected to supports to hold the cover relatively taut. In use, the load between the cover and the supports can be significant and arises from the weight of the cover, tension of the cover, wind caught by the cover and the weight of rain on the cover, among other things. Since the clips are attached to the fabric with the pins, the load between the cover and the support is transferred through these pins. This can result in tearing of the cover due to the high forces concentrated around the pins, which damages the cover and can cause the clip to tear loose from the cover.

Additionally, some clips attach to a rope by folding over t such that, in use, the load of the rope on the clip is borne by a flexible, relatively weak part of the clip such as a hinge. This can result in excessive wear on the clip and, ultimately, breaking of the clip at the flexible part.

It is an object of the invention to provide an improved clip that is less likely to cause tearing of a cover, less prone to breaking, and that more reliably retains a cover, or to at least provide the public or industry with a useful choice.

### SUMMARY OF THE INVENTION

According to one exemplary embodiment there is provided a clip comprising:

first and second clip body portions, each clip body portion including an elongate partial channel;

a hinge connecting the first and second clip body portions and configured to allow movement of the first and second clip body portions between an open configuration and a closed configuration;

wherein, in the closed configuration, the partial channels of the first and second clip body portions together form an elongate channel with a load-bearing inner surface on a side of the channel substantially opposite the hinge.

Preferably, at least one of the first and second clip body portions includes a raised clamping surface, the raised clamping surface(s) of the or each clip body portion configured to be brought into close proximity to the other clip body portion in the closed configuration.

Preferably the raised clamping surface is configured to be brought to within about 2 mm of the other clip body portion in the closed configuration.

Preferably the raised clamping surface of the or each clip body portion is a ridge running substantially parallel to the partial channel of the respective clip body portion.

Preferably the raised clamping surface of the or each clip body portion extends substantially the entire width of the respective clip body portion.

Preferably the raised clamping surface of the or each clip body portion is located on a side of the partial channel of the respective clip body portion substantially opposite the hinge.

Preferably the channel is substantially non-circular in cross-section.

Preferably the load-bearing surface is non-concave.

Preferably the raised clamping surface forms at least part of the load-bearing surface.

Preferably the clip comprising a closure for retaining the clip in the closed configuration.

Preferably the closure comprises:
a projection projecting from one of the first and second clip body portions; and
an aperture in the other of the first and second clip body portions.

Preferably the projection is a pin with a barbed end configured to pass through the aperture in a first direction longitudinal to the projection and be retained against release from the aperture in a second direction opposite the first direction.

Preferably the clip comprising an eyelet.

Preferably the eyelet is formed in a projection that projects from one of the first and second clip body portions.

Preferably the projection in which the eyelet is formed extends from a side of the respective clip body portion that is on a hinge side of the partial channel of the respective clip body portion.

Preferably the projection in which the eyelet is formed is substantially co-planar with the respective clip body portion from which it projects.

Preferably in the open configuration, the projection in which the eyelet is formed is located within a space of the other of the first and second clip body portions than the one from which it projects.

Preferably each of the first and second clip body portions is wider at a side near the hinge than at a side opposite the hinge.

Preferably the first and second clip body portions are substantially rigid and the hinge is substantially flexible.

Preferably the clip is integrally formed.

Preferably the clip is formed from moulded plastic.

Preferably each of the first and second clip body portions is in the form of an open shell.

Preferably each of the first and second clip body portions includes strengthening ribs in an open side of the open shell.

According to another exemplary embodiment there is provided a cover assembly comprising:
a fabric cover including a rope, wire, cable or rod extending along an edge of the fabric cover;
one or more clips configured to retain the fabric cover, the one or more clips comprising:
first and second clip body portions, each clip body portion including an elongate partial channel;
a hinge connecting the first and second clip body portions and configured to allow movement of the first and second clip body portions between an open configuration and a closed configuration;
wherein, in the closed configuration, the partial channels of the first and second clip body portions together form an elongate channel configured to at least partially enclose the rope, wire, cable or rod of the fabric cover, the channel having a load-bearing inner surface on a side of the channel substantially opposite the hinge configured to bear a load applied by the rope, wire, cable or rod of the fabric cover.

Preferably the rope, wire, cable or rod extends along substantially the entire length of the edge of the fabric cover.

Preferably the rope, wire, cable or rod is located at least partially within a tubular portion of the fabric cover.

Preferably the tubular portion of the fabric cover extends along substantially the entire length of the edge of the fabric cover.

Preferably the channel of the one or more clips is configured to retain the rope, wire, cable or rod of the fabric cover.

Preferably the one or more clips each include an eyelet.

According to a further exemplary embodiment there is provided a kit of parts comprising:
a fabric cover;
one or more clips configured to retain the fabric cover, the one or more clips comprising:
first and second clip body portions, each clip body portion including an elongate partial channel;
a hinge connecting the first and second clip body portions and configured to allow movement of the first and second clip body portions between an open configuration and a closed configuration;
wherein, in the closed configuration, the partial channels of the first and second clip body portions together form an elongate channel configured to at least partially enclose a rope, wire, cable or rod located about an edge of the fabric cover, the channel having a load-bearing inner surface on a side of the channel substantially opposite the hinge configured to bear a load applied by the rope, wire, cable or rod.

Preferably the kit further comprising the rope, wire, cable or rod, wherein the rope, wire, cable or rod is retained in or forms part of the fabric cover.

Preferably each of the one or more clips includes an eyelet configured to receive a connector.

Preferably the kit further comprising a support configured to support at least one of the one or more clips.

Preferably the support is a rope, wire or cable.

Preferably a connector extends through the eyelet(s) of each of at least one of the one or more clips and the support is configured to extend through one or more connectors.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows an isometric top view of an illustrative example of a clip;

FIG. 2 shows a isometric bottom view of an illustrative example of a clip;

FIG. 3 shows a side view of an illustrative example of a clip attached to a cover;

FIG. 4 shows an illustrative example of the clip attached to a cover and a support;

FIG. 5 shows an illustrative example of a cover assembly;

FIG. 6 shows an illustrative example of a kit including a plurality of clips and a cover;

FIG. 7 shows an illustrative example of a disassembled kit;

FIG. 8 shows an illustrative example of a partially assembled kit; and

FIG. 9 shows an illustrative example of an assembled kit.

### DETAILED DESCRIPTION OF EMBODIMENTS OF THE INVENTION

Clips provide a convenient way of attaching fabric covers to supports but can damage the cover or tear loose from it when a load is placed on the cover.

There is thus provided a clip that may improve the reliability of a covering system and reduce damage on a fabric cover; a cover assembly including such a clip; and a kit of parts including a cover and a clip.

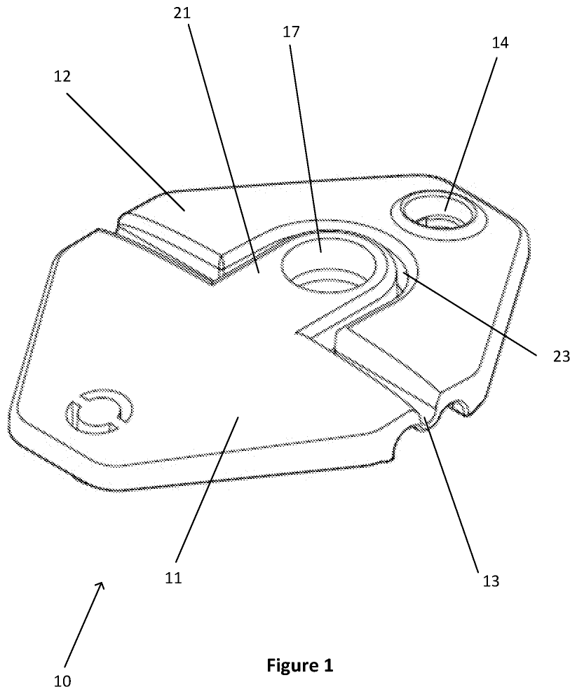

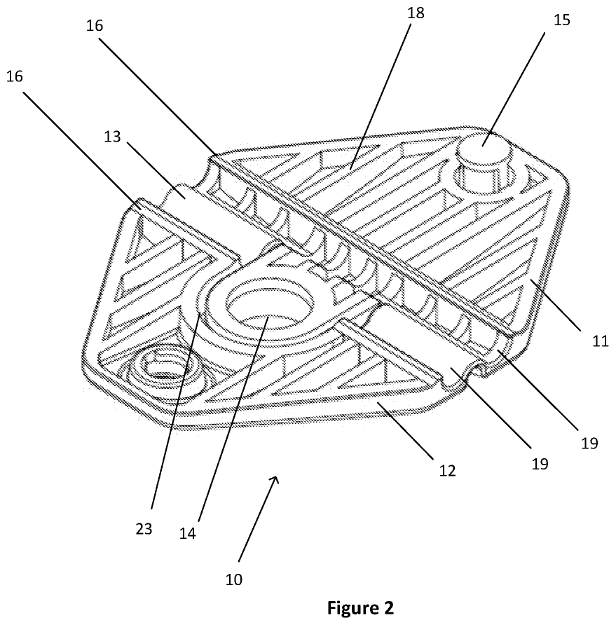

An illustrative example of a clip 10 is shown in FIGS. 1 and 2, As can be seen in these figures, the clip 10 includes first 11 and second 12 body portions, each of which has an elongate partial channel 19. In the example of FIGS. 1 and 2 the partial channels 19 are shown at the edges of the respective body portions 11, 12, but it will be appreciated that they could be elsewhere in the body portions 11, 12, for example near the center.

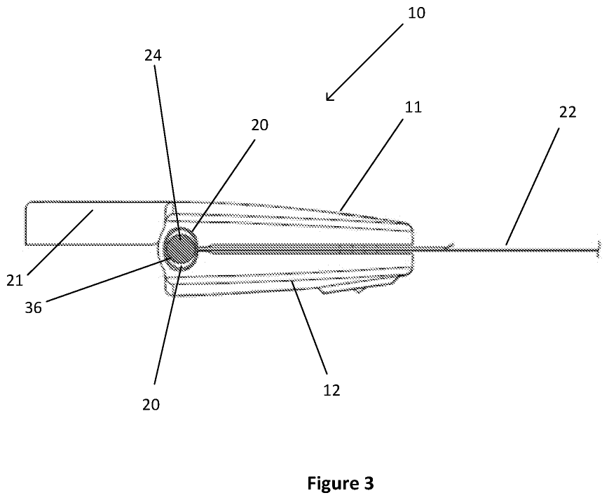

The two body portions 11, 12 are connected via a hinge 13. The hinge 13 allows relative movement between the body portions 11, 12 into an open configuration, as shown in FIGS. 1 and 2, or a closed configuration, as shown in FIG. 3. In the open configuration the clip 10 is open at one side, allowing the clip 10 to be placed over an item to be clipped. In the closed configuration, the two clip body portions are brought together to clip the item. The hinge 13 could be formed from a relatively flexible strip of material, a barrel-type hinge, or any other hinge allowing the clip 10 to move between the opened and closed configurations.

The partial channels 19 of the first and second body portions are brought together in the closed configuration to form an elongate channel. The elongate channel has a load-bearing inner surface on the side substantially opposite the hinge 13—e.g. approximately in the region where the first and second clip body portions come together to form the channel. This load-bearing surface 20 can bear the load of a clipped item in use and means that load applied to the clipped item via the clip 10, for example from a support rope, is transferred to the portion of the clipped item that is within the channel and adjacent the load-bearing surface 20.

There are various different possible configurations of the load-bearing surface 20. In one arrangement, the partial channels 19 could be semi-circular in cross section such that the channel, when formed, has a circular cross section. In another arrangement, the partial channels 19 are shaped such that the channel, when formed, has a non-circular cross-section with a non-concave inner surface in the region intended to have the load-bearing surface 20. Body portions that together form a non-concave surface, such as a flat or convex surface, resist being forced apart when pressure is applied to the surface. In another arrangement, the partial channels 19 include interdigitating projections that come together in the closed configuration to form a concave load-bearing surface 20. Interdigitating projections can also resist being forced apart when pressure is applied to the surface. In another arrangement, the clip 10 can be designed with portions that are sufficiently rigid to bear the load of the clipped item in use, or with a closure that retains the clip 10 in the closed configuration with sufficient strength to enable the inner surface of the channel to bear the load without opening under the load. It will be appreciated that many other configurations of the load-bearing surface 20 are possible, and that the arrangements described above could be used separately or in combination.

As mentioned above, the clip 10 can include a closure for retaining the clip 10 in a closed configuration. In FIGS. 1 and 2, this is formed from a pin 15 projecting from the first clip body portion 11 and an aperture 14 in the second clip body portion 12. When closing the clip 10, the pin 15 can be pushed longitudinally through the aperture 14 and resist being removed in the opposite direction. The pin 15 may be provided with a barb or other arrangement for resisting removal, for example the pin 15 could have a transverse hole through it for receiving a split pin that prevents the pin 15 passing back through the aperture 14 once the split pin is inserted. It will be appreciated that other forms of closure are possible such as the aperture 14 and the pin 15 being a friction or push fit.

One or both of the first 11 and second 12 clip body portions can also have a raised clamping surface 16 that can clamp onto a clipped item in the case that the clipped item extends out of the channel, for example if the clipped item is a fabric cover. The raised clamping surface 16 creates a region of reduced separation between the first 11 and second 12 clip body portions in the closed configuration that clamps the clipped item relatively tightly between the body portions in that region. This distributes the tension of the cover across a relatively large area of the clip 10, reducing the chance of damage to the cover.

The separation in the region of the raised clamping surface(s) 16 may depend on the thickness and expected load of the item to be clipped, for example it could be less than 10 mm, less than about 5 mm, less than about 3 mm, or approximately 2 mm, while the separation between the clip body portions elsewhere than in the region of the raised clamping surface(s) 16 could be less than about 20 mm, less than about 10 mm, less than about 6 mm, or approximately 4 mm. The raised clamping surface 16 can be a ridge that runs substantially parallel to the partial channel 19 of the clip body portion. In one arrangement, the ridge runs along the side of the partial channel 19 that is opposite the hinge 13. The raised clamping surface(s) 16 can extend all or part of the way across the body portion. In this position, the ridge can also form part of the load-bearing surface 20, which simplifies design and construction of the clip 10.

Also shown in FIG. 1 is an eyelet 17 that can be used to attach the clip 10 to a support such as a rope, cable or wire. The clip 10 may be attached to a support 26 via a connector 27 such as for example a rope, tie, ring, shackle or carabine. For example, when the clip 10 is used to hold a cover that has a rope running along its edge, the cover can be supported between two or more tensioned cables with a connector 27 connecting the clip to the supports 26 to create a taut cover assembly. It will be understood that the eyelet 17 could also pass over a hook or post, depending on the application.

In the example of FIG. 1, the eyelet 17 is formed in projection 21 that is coplanar with, and projects from, the first clip body portion 11. Forming the eyelet projection 21 integrally with the clip body portion simplifies manufacture and robustness of the clip 10. As shown, the eyelet projection 21 can extend from the hinge side of the partial channel 19. The other clip body portion can include a space 23 into which the projection 21 fits when the clip 10 is in the open configuration. When the clip 10 is in the closed configuration, the eyelet 17 can be located at or beyond the hinge side of the channel. This locates the eyelet 17 outside the area which will be occupied by a clipped cover or other clipped item in use, meaning that the support is less likely to interfere with the cover, a clipped rope or similar, and will not need to pass through a hole in the clipped cover. Reducing the number of holes in a clipped item and spatially separating the support from the item may reduce the chance of damage to the cover or other clipped item. Additionally, having the support on the opposite side of the channel from the one at which the clip 10 opens to receive a cover and clip it means that, when in use, the cover and support will apply forces in substantially opposite directions from each other, both directions pointing away from the channel. These forces act to hold the clip 10 in a fixed orientation substantially coplanar with the cover and prevent the clip 10 from twisting about a rope that passes through the channel. This may reduce the chance of damage to the cover and failure of the clip 10.

In other arrangements, the eyelet 17 may be located at other parts of the clip 10. The eyelet 17 could also be formed from a tie or other flexible material.

The clip 10 can be formed in various shapes. Having wide body portions in the region of the load-bearing surface 20 allows the load to be distributed to a relatively wide portion of the item, such as a rope, clipped in the channel. Similarly, having wide body portions in the region of the raised clamping portions 16 allows the tension of a clipped item, such as a fabric or netting cover, to be applied to the clip 10 across a relatively wide portion of the item. The example of FIG. 1 has clip body portions 11, 12 that are wide near the hinge 13 and relatively narrow away from the hinge 13. The load-bearing surface 20 and clamping surface are at the wide portion. Since the clip 10 does not rely on multiple widely spaced pins to transfer load to the fabric, the body portions located away from the load-bearing surface 20 and raised clamping surface do not need to be wide. Reducing the width of portions of the clip 10 can reduce material costs.

As mentioned previously, the hinge 13 can be formed from a flexible strip of material. The clip body portions can be rigid. The clip 10 can be integrally formed and the flexible hinge 13 and rigid clip body portions can be made from the same material in different thicknesses. The clip 10 can be formed from molded plastic.

To further reduce materials without compromising strength, the clip body portions can be of “open shell” construction. They can also include strengthening ribs 18 in the open parts to retain rigidity of the body portions 11, 12 while keeping the amount of material used to a minimum.

FIG. 3 shows the clip 10 in a closed configuration and clipped to a cover 22. A rope 24 is shown at the edge of the cover 22, in this case between two layers of the cover 22. The rope 24 can bear against the load-bearing surface 20 formed at the side of the channel 36. FIG. 3 shows raised clamping portions 16 at the edge of the channel that also form part of the load-bearing surface 20. The cover 22 is clamped between these and passes out of the clip 10 away from the hinge 13. The clip 10 is held closed by a pin 15 (not shown) extending from the first clip body portion 11, through the cover 22 and through an aperture 14 in the second body portion 12, in which it is retained with a barb.

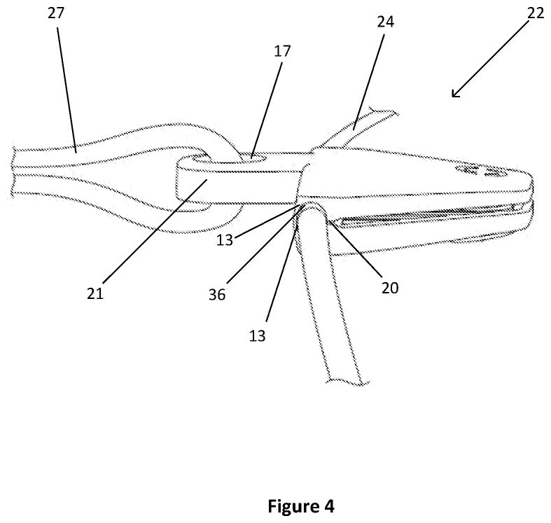

FIG. 4 depicts the clip 10 in use attached to a cover 22 and a connector 27. Only the rope, wire, cable or rod 24 of the cover 22 is shown, the fabric part of the cover 22 is not shown for clarity. This figure shows how the clipped cover 22 bears against the load-bearing surface 20 in use. In this example, the cover 22 includes a rope 24 along its edge which is located in the channel 36 such that the rope 24 is pulled against the load-bearing surface 20 by the opposing forces applied by the cover 22 and the connector 27. The clip 10 transfers the force applied by the connector 27 to the cover 22 via the load-bearing surface 20. In particular, the force is applied to the rope 24 in this example, allowing the rope 24 to distribute this force widely across the cover 22. It will be understood that similar principles apply when the cover 22 does not include a rope 24, for example when it has a wire, cable or rod that can be located in the channel 36. It should be noted that load-bearing surface 20 is not in the hinge part of the clip 10. In particular, it is on the opposite side of the channel 36 from the hinge 13, which may be relatively weak or otherwise not suitable to bear the load between the cover 22 and the supports 26.

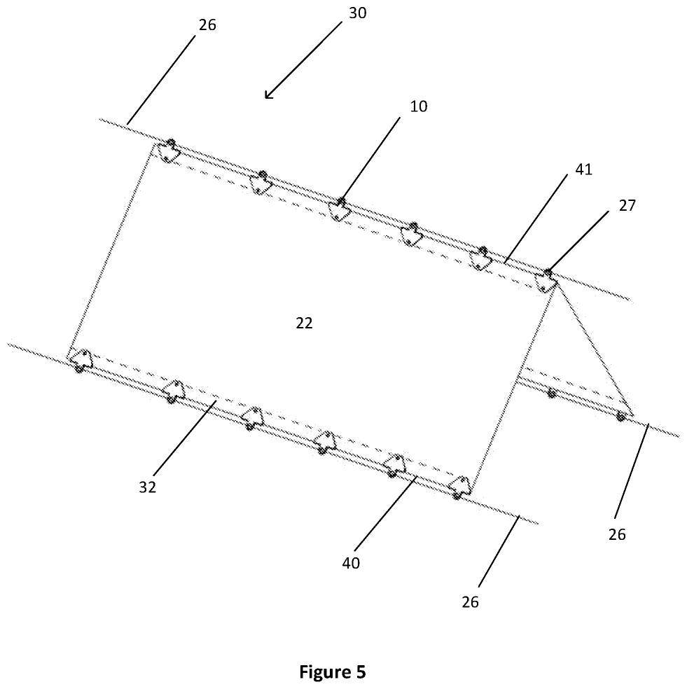

FIG. 5 shows a cover assembly 30 including several clips 10 as described above and a fabric cover 22. The fabric cover 22 has a rope, wire, cable or rod 24 extending along an edge 40 of the fabric cover 22. It may extend along all or only some of the edges 40, 41 of the cover 22. The rope, wire, cable or rod 24 could be located at least partially in a tubular passage 32 along the edge of the cover 22. For example, the cover 22 could be produced by folding the fabric over the rope, wire, cable or rod 24 and heat welding it to itself to form a tubular passage 32. In other examples, the fabric could be stitched to itself to form a tubular passage 32 instead of heat welded, or a rope may be stitched directly to the fabric. In some examples the cover 22 can retain the rope, wire, cable or rod 24, in other cases it may only loosely encircle it. It is not necessary that the rope, wire, cable or rod 24 is permanently attached to the cover 22. For example, the fabric could simply be folded over the rope, wire, cable or rod 24 and clipped into place during installation.

In FIG. 5, the cover 22 is held between two elongate supports 26 such as ropes, cables or wires with a connector 27 connecting the clip 10 to the supports 26. The supports 26 may be securely attached at their ends. When installed, the cover 22 can be held taut between the supports 26. As detailed with reference to FIG. 4, the force of the supports 26 pulling the cover 22 tight is transferred, via the connector 27 and load-bearing surface 20, to the rope, wire, cable or rod 24 at edges of the cover 22. This distributes tension evenly across the cover 22.

The fabric of the cover 22 could be a close-woven fabric such as canvas, a loose-weave fabric or netting, a continuous webbing such as a plastic sheet, or other types of fabric. It will be understood that the type of cover 22 will depend on the application and is not limited to any particular type of fabric.

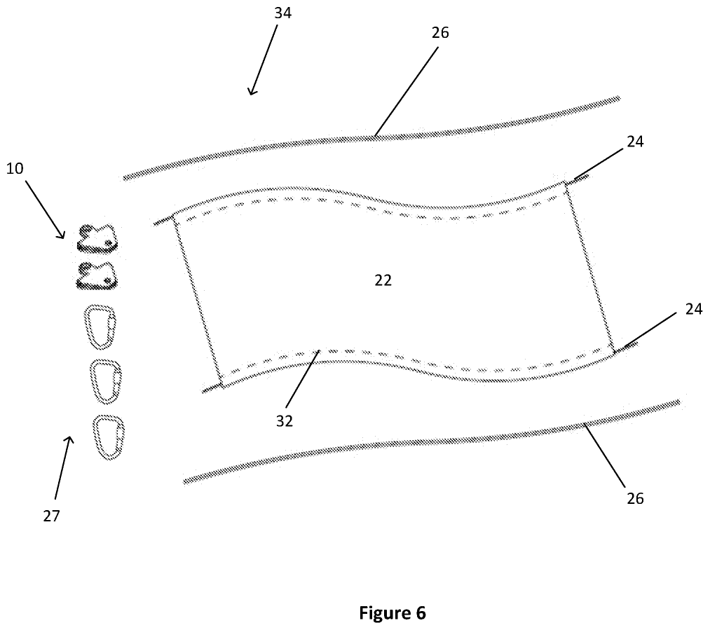

The clip 10 and cover 22 may be parts of a kit 34 as shown in FIG. 6. The kit 34 includes one or more clips 10 as described above and a fabric cover 22. The kit 34 may also include a rope, wire, cable or rod 24 that is to be located about the edge of the fabric cover 22 in use. This may be provided in or on the fabric cover 22 as described previously or may be provided separate from the cover 22. The kit 34 may also include at least one support 26 such as rope or cable and connectors 27 for supporting the cover 22 in use.

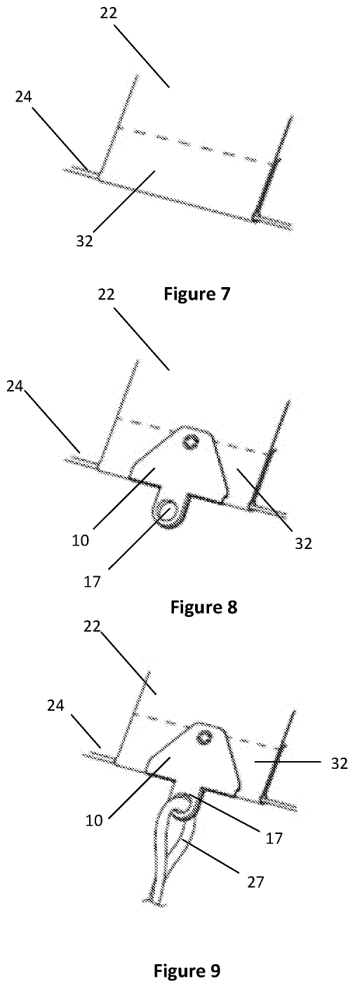

FIGS. 7 to 9 show an example kit 34 in various stages of assembly. In this example, the kit 34 is described in terms of the rope, wire, cable or rod 24 being a rope and the support 26 being a cable, however it will be understood that the kit can be used with any of the rope, wire cable or rod about the edge of the cover 22 and with any other kind of support 26, for example a wire or rope.

FIG. 7 shows a fabric cover 22 with a rope 24 located at the edge of the cover 22. The cover 22 may be provided with the rope 24 already in or forming part of the cover 22 or the user may assemble the rope 24 and cover 22 at the time of installation, using their own rope 24 or one provided in the kit. FIG. 8 shows a clip 10 applied to the cover 22 and rope 24. When applying the clip 10, the rope 24 is located between the partial channels 19 of the two clip body portions such that, when closed, it is within the channel 36. The clip 10 can be retained in the closed position by a pin that is pushed through the fabric of the cover 22 and an aperture during closing. FIG. 9 shows a cable support 26 passing through the eyelet 17 of the clip 10 to support the cover 22 in use. The user may use their own connectors or connectors 27 may be provided in the kit 34. The user may use their own cables 26 or cables may be provided in the kit 34.

The use of connector 27 to connect the clip 10 to a wire or rope support 26 allows for the fabric cover 22 to be pulled to one end of the cables 26 when the fabric cover 22 is not needed to protect the plants. In an alternative embodiment the eyelet 17 could be arranged on the clip 10 to allow the supports 26 to pass through the eyelet 17 without the use of a connector 27. In this embodiment the axis eyelet would be rotated 90 degrees to that illustrated.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader embodiments is not limited to the specific details, representative apparatus and method, and illustrative examples shown and described. Accordingly, departures may be made from such details without departure from the spirit or scope of the Applicant's general inventive concept.

Having described various devices and methods, certain embodiments and embodiments can include:

In a first embodiment, a clip comprises: first and second clip body portions, each clip body portion including an elongate partial channel; and a hinge connecting the first and second clip body portions and configured to allow movement of the first and second clip body portions between an open configuration and a closed configuration, wherein, in the closed configuration, the partial channels of the first and second clip body portions together form an elongate channel with a load-bearing inner surface on a side of the channel substantially opposite the hinge.

A second embodiment can include the clip of the first embodiment, wherein at least one of the first and second clip body portions includes a raised clamping surface, the raised clamping surface(s) of the or each clip body portion configured to be brought into close proximity to the other clip body portion in the closed configuration.

A third embodiment can include the clip of the second embodiment, where the raised clamping surface is configured to be brought to within about 2 mm of the other clip body portion in the closed configuration.

A fourth embodiment can include the clip of the first to third embodiment, wherein the raised clamping surface of the or each clip body portion is a ridge running substantially parallel to the partial channel of the respective clip body portion.

A fifth embodiment can include the clip of any one of the first to fourth embodiments, wherein the raised clamping surface of the or each clip body portion extends substantially the entire width of the respective clip body portion.

A sixth embodiment can include the clip of any one of the first to fifth embodiments, wherein the raised clamping surface of the or each clip body portion is located on a side of the partial channel of the respective clip body portion substantially opposite the hinge.

A seventh embodiment can include the clip of any one of the first to sixth embodiments, wherein the channel is substantially non-circular in cross-section.

An eighth embodiment can include the clip of the seventh embodiment, wherein the load-bearing surface is non-concave.

A ninth embodiment can include the clip of the sixth embodiment, wherein the raised clamping surface forms at least part of the load-bearing surface.

A tenth embodiment can include the clip of any one of the first to ninth embodiments, further comprising a closure for retaining the clip in the closed configuration.

An eleventh embodiment can include the clip of the tenth embodiment, wherein the closure comprises: a projection projecting from one of the first and second clip body portions; and an aperture in the other of the first and second clip body portions.

A twelfth embodiment can include the clip of the eleventh embodiment, wherein the projection is a pin with a barbed end configured to pass through the aperture in a first direction longitudinal to the projection and be retained against release from the aperture in a second direction opposite the first direction.

A thirteenth embodiment can include the clip of any one of the first to twelfth embodiments, further comprising an eyelet.

A fourteenth embodiment can include the clip of the thirteenth embodiment, wherein the eyelet is formed in a projection that projects from one of the first and second clip body portions.

A fifteenth embodiment can include the clip of the fourteenth embodiment, wherein the projection in which the eyelet is formed extends from a side of the respective clip body portion that is on a hinge side of the partial channel of the respective clip body portion.

A sixteenth embodiment can include the clip of the fourteenth or fifteenth embodiment, wherein the projection in which the eyelet is formed is substantially co-planar with the respective clip body portion from which it projects.

A seventeenth embodiment can include the clip of any one of the fourteenth to sixteenth embodiments, wherein, in the open configuration, the projection in which the eyelet is formed is located within a space of the other of the first and second clip body portions than the one from which it projects.

An eighteenth embodiment can include the clip of any one of the first to seventeenth embodiments, wherein each of the first and second clip body portions is wider at a side near the hinge than at a side opposite the hinge.

A nineteenth embodiment can include the clip of any one of the first to eighteenth embodiments, wherein the first and second clip body portions are substantially rigid and the hinge is substantially flexible.

A twentieth embodiment can include the clip of any one of the first to nineteenth embodiments, wherein the clip is integrally formed.

A twenty first embodiment can include the clip of the twentieth embodiment, wherein the clip is formed from moulded plastic.

A twenty second embodiment can include the clip of any one of the first to twenty first embodiments, wherein each of the first and second clip body portions is in the form of an open shell.

A twenty third embodiment can include the clip of the twenty second embodiment, wherein each of the first and second clip body portions includes strengthening ribs in an open side of the open shell.

In a twenty fourth embodiment, a cover assembly comprises: a fabric cover including a rope, wire, cable or rod extending along an edge of the fabric cover; one or more clips configured to retain the fabric cover, the one or more clips comprising: first and second clip body portions, each clip body portion including an elongate partial channel; and a hinge connecting the first and second clip body portions and configured to allow movement of the first and second clip body portions between an open configuration and a closed configuration, wherein, in the closed configuration, the partial channels of the first and second clip body portions together form an elongate channel configured to at least partially enclose the rope, wire, cable or rod of the fabric cover, the channel having a load-bearing inner surface on a side of the channel substantially opposite the hinge configured to bear a load applied by the rope, wire, cable or rod of the fabric cover.

A twenty fifth embodiment can include the cover assembly of the twenty fourth embodiment, wherein the rope, wire, cable or rod extends along substantially the entire length of the edge of the fabric cover.

A twenty sixth embodiment can include the cover assembly of the twenty fourth or twenty fifth embodiment, wherein the rope, wire, cable or rod is located at least partially within a tubular portion of the fabric cover.

A twenty seventh embodiment can include the cover assembly of the twenty fifth embodiment, wherein the tubular portion of the fabric cover extends along substantially the entire length of the edge of the fabric cover.

A twenty eighth embodiment can include the cover assembly of any one of the twenty fourth to twenty seventh embodiments, wherein the channel of the one or more clips is configured to retain the rope, wire, cable or rod of the fabric cover.

A twenty ninth embodiment can include the cover assembly of any one of the twenty fourth to twenty eighth embodiments, wherein the one or more clips each include an eyelet.

In a thirtieth embodiment, a kit of parts comprises: a fabric cover; one or more clips configured to retain the fabric cover, the one or more clips comprising: first and second clip body portions, each clip body portion including an elongate partial channel; a hinge connecting the first and second clip body portions and configured to allow movement of the first and second clip body portions between an open configuration and a closed configuration; wherein, in the closed configuration, the partial channels of the first and second clip body portions together form an elongate channel configured to at least partially enclose a rope, wire, cable or rod located about an edge of the fabric cover, the channel having a load-bearing inner surface on a side of the channel substantially opposite the hinge configured to bear a load applied by the rope, wire, cable or rod.

A thirty first embodiment can include the kit of parts of the thirtieth embodiment, further comprising the rope, wire, cable or rod, wherein the rope, wire, cable or rod is retained in or forms part of the fabric cover.

A thirty second embodiment can include the kit of parts of the thirtieth or thirty first embodiment, wherein each of the one or more clips includes an eyelet configured to receive a connector.

A thirty third embodiment can include the kit of parts of any one of the thirtieth to thirty second embodiment, further comprising a support configured to support at least one of the one or more clips.

A thirty fourth embodiment can include the kit of parts of the thirty third embodiment, wherein the support is a rope, wire or cable.

A thirty fifth embodiment can include the kit of parts of the thirty third or thirty fourth embodiments, when including the thirty second embodiment, wherein a connector extends through the eyelet(s) of each of at least one of the one or more clips and the support is configured to extend through one or more connectors.

1. A clip comprising:
first and second clip body portions, each clip body portion including an elongate partial channel; and
a hinge connecting the first and second clip body portions and configured to allow movement of the first and second clip body portions between an open configuration and a closed configuration,
wherein, in the closed configuration, the partial channels of the first and second clip body portions together form an elongate channel with a load-bearing inner surface on a side of the channel substantially opposite the hinge.

2. The clip as claimed in claim 1, wherein at least one of the first and second clip body portions includes a raised clamping surface, the raised clamping surface(s) of the or each clip body portion configured to be brought into close proximity to the other clip body portion in the closed configuration.

3. The clip as claimed in claim 2, where the raised clamping surface is configured to be brought to within about 2 mm of the other clip body portion in the closed configuration.

4. The clip as claimed in claim 2, wherein the raised clamping surface of the or each clip body portion is a ridge running substantially parallel to the partial channel of the respective clip body portion.

5. The clip as claimed in claim 2, wherein the raised clamping surface of the or each clip body portion extends substantially an entire width of the respective clip body portion.

6. The clip as claimed in claim 2, wherein the raised clamping surface of the or each clip body portion is located on a side of the partial channel of the respective clip body portion substantially opposite the hinge.

7. The clip as claimed in claim 1, wherein the channel is substantially non-circular in cross-section and the load-bearing surface is non-concave.

8. The clip as claimed in claim 6, wherein the raised clamping surface forms at least part of the load-bearing surface.

9. The clip as claimed in claim 1, further comprising a closure for retaining the clip in the closed configuration wherein the closure comprises:
a projection projecting from one of the first and second clip body portions; and
an aperture in the other of the first and second clip body portions.

10. The clip as claimed in claim 1, further comprising an eyelet and wherein the eyelet is formed in a projection that projects from one of the first and second clip body portions.

11. The clip as claimed in claim 10, wherein the eyelet is formed in a projection that projects from one of the first and second clip body portions, wherein the projection in which the eyelet is formed extends from a side of the respective clip body portion that is on a hinge side of the partial channel of the respective clip body portion and wherein the projection in which the eyelet is formed is substantially co-planar with the respective clip body portion from which it projects.

12. The clip as claimed in claim 11, wherein, in the open configuration, the projection in which the eyelet is formed is located within a space of the other of the first and second clip body portions than the one from which it projects.

13. The clip as claimed in claim 1, wherein the first and second clip body portions are substantially rigid and the hinge is substantially flexible.

14. The clip as claimed in claim 1, wherein each of the first and second clip body portions is in the form of an open shell and wherein each of the first and second clip body portions includes strengthening ribs in an open side of the open shell.

15. A cover assembly comprising:
a fabric cover including a rope, wire, cable or rod extending along an edge of the fabric cover;
one or more clips configured to retain the fabric cover, the one or more clips comprising:
first and second clip body portions, each clip body portion including an elongate partial channel; and
a hinge connecting the first and second clip body portions and configured to allow movement of the first and second clip body portions between an open configuration and a closed configuration,
wherein, in the closed configuration, the partial channels of the first and second clip body portions together form an elongate channel configured to at least partially enclose the rope, wire, cable or rod of the fabric cover, the channel having a load-bearing inner surface on a side of the channel substantially opposite the hinge configured to bear a load applied by the rope, wire, cable or rod of the fabric cover.

16. The cover assembly as claimed in claim 15, wherein the rope, wire, cable or rod extends along substantially an entire length of the edge of the fabric cover.

17. The cover assembly as claimed in claim 15, wherein the rope, wire, cable or rod is located at least partially within a tubular portion of the fabric cover.

18. The cover assembly as claimed in claim 17, wherein the tubular portion of the fabric cover extends along substantially an entire length of the edge of the fabric cover.

19. The cover assembly as claimed in 15, wherein the channel of the one or more clips is configured to retain the rope, wire, cable or rod of the fabric cover.

20. A kit of parts comprising:
a fabric cover;
one or more clips configured to retain the fabric cover, the one or more clips comprising:
first and second clip body portions, each clip body portion including an elongate partial channel;
a hinge connecting the first and second clip body portions and configured to allow movement of the first and second clip body portions between an open configuration and a closed configuration;
wherein, in the closed configuration, the partial channels of the first and second clip body portions together form an elongate channel configured to at least partially enclose a rope, wire, cable or rod located about an edge of the fabric cover, the channel having a load-bearing inner surface on a side of the channel substantially opposite the hinge configured to bear a load applied by the rope, wire, cable or rod.
